(19) United States
(12) Patent Application Publication
(10) Pub. No.: US 2009/0064585 A1
(43) Pub. Date: Mar. 12, 2009

(54) ODORISATION OF FUEL GAS WITH LOW-SULFUR ODORANTS

(75) Inventors: Gerd Mansfeld, Eschershausen (DE); Jorg Eilers, Holzminden (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Symrise GmbH & Co. KG, Holzminden (DE)

(21) Appl. No.: 10/596,580

(22) PCT Filed: Dec. 1, 2004
(86) PCT No.: PCT/EP2004/053202

§ 371 Date: Nov. 18, 2008

(30) Foreign Application Priority Data
Dec. 19, 2003 (DE) 103597433

(51) Int. Cl. C01B 3/32

(52) U.S. Cl. 48/127.3

(57) ABSTRACT

The use is described of a mixture containing
A) at least two different acrylic acid C₁-C₆ alkyl esters;
B) at least one compound from the group comprising C₁-C₈ mercaptans, C₄-C₁₂ thiophenes, C₂-C₈ sulfides or C₂-C₈ disulfides;
C) at least one compound from the group comprising norbornenes, C₁-C₅ carboxylic acids, C₁-C₈ aldehydes, C₆-C₁₄ phenols, C₇-C₁₄ anisoles or C₄-C₁₄ pyrazines;
D) optionally an antioxidant
for the odorisation of fuel gas having a methane content of at least 60 wt. %.

Corresponding fuel gases and processes for the odorisation of fuel gases are also described.

The present invention concerns the use of an acrylic acid alkyl ester mixture containing a small proportion of a sulfur-containing compound and a further component for the odorisation of fuel gas, a process for the odorisation of fuel gas and fuel gas containing this mixture.

The town and coke oven gases formerly used for the public supply of gas contained strongly smelling components and therefore had a strong characteristic odour, so gas leaks could easily be detected.

Gas odorisation is understood to be the addition of strong-smelling substances (odorants) acting as warning or alarm substances to gases which do not have a significant characteristic odour, i.e. to otherwise substantially or entirely odourless gases.

Natural gas consists mainly of methane (typical methane contents range from 50 to 99 wt. %, mostly from 60 to 99 wt. % and conventionally 80 to 99 wt. %) and, depending on its origin, can also contain varying proportions of ethane, propane and higher-molecular-weight hydrocarbons. Natural gas H(H=high) has a methane content of 87 to 99.1 vol. %, whilst natural gas L (L=low) generally contains 79.8 to 87 vol. % methane.

By virtue of its high degree of purity, the gas currently used in the public supply network, conventionally obtained from natural gas, is inherently virtually odourless.

If leaks are not discovered promptly, explosive gas/air mixtures quickly form, with a high risk potential.

For safety reasons gas is therefore odorised by the addition of strongly smelling substances. This in Germany, for example, all gases which do not have an adequate characteristic odour and which are distributed in the public gas supply system are required to be odorised in accordance with DVGW worksheet G 280 (DVGW=Deutscher Verein des Gas-und Wasserfaches e.V.). These odorants are perceptible even when highly diluted, and because of their exceptionally unpleasant odour they provoke an alarm association in people in the desired way. The odorant must not only have an unpleasant and unmistakable odour but above all must clearly constitute a warning odour. The smell of the odorised gas must therefore not be familiar to people from everyday life, e.g. from the kitchen or home. In Germany, approximately 90% of utility gas is currently odorised with tetrahydrothiophene (THT) (12-25 mg/m³); odorisation with mercaptans is also customary.

It can be sensible to add a larger amount of odorant to the gas over a longer period. In this increased odorisation, in comparison to conventional odorisation, up to three times the amount of odorant is added. Increased odorisation is used for example when new networks or line sections are brought into use, in order to reach the minimum odorant concentration more quickly or to identify minor leaks in the gas installation.

THT on its own is extremely suitable for a reliable odorisation of gas. However, as part of a more sensitive approach to the environment, it must be borne in mind that the combustion of gases odorised in this way produces relatively high levels of sulfur oxides as combustion products.

Since the aim is to reduce or avoid sulfur compounds, attempts have already been made to develop low-sulfur or sulfur-free odorants.

JP-B-51-007481 mentions that acrylic acid alkyl esters such as methyl acrylate, ethyl acrylate and butyl acrylate are known to have poor odorising properties for fuel gases and have practically no importance in this regard. The document describes and claims allyl acrylate as an effective odorising component.

JP-A 55-104393 states that odorants containing an alkyne and at least two compounds chosen from a group comprising methyl acrylate, ethyl acrylate, methyl methacrylate, allyl methacrylate, ethyl propionate, methyl n-butyrate, methyl isobutyrate and phenyl acrylate, and optionally tert-butyl mercaptan, are suitable for the odorisation of fuel gases. The amount of odorant, based on weight, is 50 ppm (mg/kg gas), preferably greater than or equal to 100 ppm. The best results for LPG (liquid gas) were obtained with mixtures comprising TBM. A better odorising effect was achieved by adding 2-butyne (50 ppm) to a mixture of methyl acrylate (50 ppm), allyl acrylate (100 ppm) and TBM (5 ppm). A mixture comprising 2-butyne (50 ppm), allyl methacrylate (20 ppm), methyl acrylate (20 ppm), methyl n-butyrate (20 ppm), methyl isobutyrate (20 ppm), ethyl propionate (20 ppm) and TBM (5 ppm) had the best results.

In JP-B-51-034841 “odour threshold values” were calculated for various substances, n-valeric acid, n-butyric acid, isobutyraldehyde and various methylamines having low olfactory “odour threshold values”. Due to their olfactory properties, ethyl acrylate or n-valeric acid used alone did not have an adequate odorising effect. The optimised mixture comprised 50-90 wt. % of ethyl acrylate, 10-50 wt. % of n-valeric acid and optionally triethylamine. The optimised mixture comprised ethyl acrylate, n-valeric acid and triethylamine, wherein this mixture contained equal parts by weight of n-valeric acid and triethylamine and 30 to 80 wt. % of ethyl acrylate. A mixture consisting of 60 wt. % of ethyl acrylate and 20 wt. % each of n-valeric acid and triethylamine was added to a gaseous fuel gas in a quantity of 10 mg/m³.

Odorants for fuel gases consisting of ethyl acrylate (70 wt. %) and tert-butyl mercaptan (30 wt. %) are known from JP-B 51-021402. This mixture was added to a gaseous fuel gas in a quantity of 5 mg/m³.

Odorants for the odorisation of heating gases consisting of a) 30-70 wt. % C₁-C₄ alkyl mercaptans, b) 10-30 wt. % n-valeraldehyde and/or isovaleraldehyde, n-butyric acid and/or isobutyric acid and optionally c) up to 60 wt. % of tetrahydrothiophene are described in DE-A 31 51 215. These odorants were added to heating gas in quantities of 5-40 mg/m³.

Mixtures containing a) 1 percent by weight of dimethyl sulfide, b) 0.8-3 percent by weight of tert-butyl mercaptan and c) 0.1-0.2 percent by weight of tert-heptyl mercaptan or 0.05-0.3 percent by weight of tert-hexyl mercaptan for the odorisation of fuel gases are known from JP-A 61-223094. These mixtures had an odour of tert-butyl mercaptan, which is associated with the odour of town gas.

The use of norbornene derivatives for fuel gas odorisation is known from JP-A 55056190. 40 mg/kg of a mixture of equal parts of 5-ethylidene-2-norbornene and 5-vinyl-2-norbornene or 50 mg/kg of a mixture of 80 wt. % of 5-ethylidene-2-norbornene and 20 wt. % of ethyl acrylate were added to LPG.

Mixtures containing norbornene or a norbornene derivative and a diluent for the odorisation of town gas are described in DE-A 100 58 805.

Mixtures of C₄-C₇-aldehydes and sulfur compounds are described as odorants in JP-A 50-126004. Odorisation of 1 kg of propane was performed with 50 mg of a mixture of 60 wt. % of valeraldehyde and 40 wt. % of n-butyl mercaptan. Valeraldehyde intensifies the odour of n-butyl mercaptan here. 2-Methyl valeraldehyde was used in a similar way.

In DE-A 19837066 the problem of sulfur-free gas odorisation was solved with mixtures containing at least one acrylic acid C₁-C₁₂ alkyl ester and a nitrogen compound having a boiling point in the range from 90 to 210° C. and a molecular weight of 80 to 160, mixtures containing at least two different acrylic acid alkyl esters being preferred. Alkyl-substituted 1,4-pyrazines are described as especially suitable nitrogen compounds.

It is known from U.S. Pat. No. 2,430,050 and DE-A 198 37 066 that antioxidants, particularly phenol derivatives, are suitable for stabilising gas odorants containing mercaptans or alkyl acrylates.

Alternative low-sulfur odorants for the odorisation of natural gas or fuel gases consisting primarily of methane were sought, which are preferably superior in their properties to the previously known odorants, in particular with regard to their warning odour, wherein in addition to the quality of the warning odour, the storage stability of the odorant is also important, so that the quality of the warning odour can also be ensured over an extended (storage) period.

The present invention provides the use of a mixture containing
A) at least two different acrylic acid C₁-C₆ alkyl esters;
B) at least one compound from the group comprising C₁-C₈ mercaptans, C₄-C₁₂ thiophenes, C₂-C₈ sulfides or C₂-C₈ disulfides;
C) at least one compound from the group comprising norbornenes, C₁-C₆ carboxylic acids, C₁-C₈ aldehydes, C₆-C₁₄ phenols, C₇-C₁₄ anisoles or C₄-C₁₄ pyrazines;
D) optionally an antioxidant
for the odorisation of fuel gases having a methane content of at least 60 wt. %.

The invention additionally concerns a corresponding process for the odorisation of fuel gases having a methane content of at least 60 wt. % with mixtures for use according to the invention. A mixture for use according to the invention is added to the fuel gas in this process. Regarding preferred embodiments, see the details of the preferred uses, which apply accordingly.

The present invention also provides fuel gases having a methane content of at least 60 wt. % containing the mixtures for use according to the invention.

The fuel gas to be odorised has a methane content of at least 60 wt. %, preferably at least 70 wt. % and particularly preferably at least 75 wt. %.

The acrylic acid C₁-C₆ alkyl esters are advantageously chosen from the group comprising acrylic acid methyl ester, acrylic acid ethyl ester, acrylic acid n-propyl ester, acrylic acid isopropyl ester, acrylic acid n-butyl ester, acrylic acid isobutyl ester, acrylic acid tert-butyl ester, acrylic acid n-pentyl ester, acrylic acid isopentyl ester and acrylic acid n-hexyl ester.

Acrylic acid C₁-C₄ alkyl esters are preferred, in particular acrylic acid methyl ester, acrylic acid ethyl ester, acrylic acid n-propyl ester, acrylic acid isopropyl ester, acrylic acid n-butyl ester and acrylic acid isobutyl ester. Acrylic acid C₁-C₄ alkyl esters which are most particularly preferred are acrylic acid methyl ester, acrylic acid ethyl ester and acrylic acid n-butyl ester.

If the mixtures for use according to the invention contain two acrylic acid C₁-C₄ alkyl esters from the group comprising acrylic acid methyl ester, acrylic acid ethyl ester and acrylic acid n-butyl ester, the preferred ratio by weight of the low-molecular-weight acrylic acid alkyl ester to the higher-molecular-weight acrylic acid alkyl ester is in the range from 9:1 to 1:9, preferably in the range from 7:3 to 3:7, in particular in the range from 3:1 to 1:4. The ratio by weight of the low-molecular-weight acrylic acid alkyl ester to the higher-molecular-weight acrylic acid alkyl ester is most particularly preferably in the range from 1:1 to 1:3.

The compounds from group A) are contained in the mixtures for use according to the invention advantageously in a proportion of 60-97 wt. %, preferably 70-95 wt. % and particularly preferably 80-95 wt. %.

The mercaptans can be, for example, ethyl mercaptan, n-propyl mercaptan, isopropyl mercaptan, n-butyl mercaptan, sec-butyl mercaptan, isobutyl mercaptan, tert-butyl mercaptan, n-pentyl mercaptan, isopentyl mercaptan, neopentyl mercaptan, n-hexyl mercaptan, isohexyl mercaptan, sec-hexyl mercaptan, neohexyl mercaptan, tert-hexyl mercaptan, n-heptyl mercaptan, isoheptyl mercaptan, sec-heptyl mercaptan, tert-heptyl mercaptan, n-octyl mercaptan, isooctyl mercaptan, sec-octyl mercaptan or tert-octyl mercaptan.

The thiophenes are advantageously thiophenes substituted with 1 to 4, preferably with one or two, C₁-C₄ alkyl and/or alkoxy groups. The thiophenes can also be hydrogenated thiophenes, tetrahydrothiophene being preferred.

The sulfides can be, for example, dimethyl sulfide, diethyl sulfide, di-n-propyl sulfide, diisopropyl sulfide, di-n-butyl sulfide, diisobutyl sulfide, ethylmethyl sulfide, methyl-n-propyl sulfide, methylisopropyl sulfide, methylisobutyl sulfide, ethylisopropyl sulfide or isobutyl isopropyl sulfide. Dimethyl sulfide, diethyl sulfide, di-n-propyl sulfide, diisopropyl sulfide, di-n-butyl sulfide and diisobutyl sulfide are preferred.

The disulfides can be, for example, dimethyl disulfide, diethyl disulfide, di-n-propyl disulfide, diisopropyl disulfide, di-n-butyl disulfide, diisobutyl disulfide, ethylmethyl disulfide, methyl-n-propyl disulfide, methylisopropyl disulfide, methylisobutyl disulfide, ethylisopropyl disulfide or isobutyl isopropyl disulfide. Dimethyl disulfide, diethyl disulfide, di-n-propyl disulfide, diisopropyl disulfide, di-n-butyl disulfide and diisobutyl disulfide are preferred.

The compounds from group B) are typically contained in the mixtures for use according to the invention in a proportion of 1-30 wt. %, advantageously 2-25 wt. %, preferably 3-15 wt. % and particularly preferably 5-10 wt. %.

The norbornenes are advantageously examples having a molecular weight of less than or equal to 130, norbornene, 2,5-norbornadiene, 5-ethylidene-2-norbornene and 5-vinyl-2-norbornene being preferred.

The carboxylic acids are advantageously acetic acid, propionic acid, n-butyric acid, isobutyric acid, n-valeric acid, isovaleric acid, n-caproic acid, isocaproic acid or 2-methylvaleric acid.

The aldehydes are advantageously acetaldehyde, propionaldehyde, n-butyraldehyde, isobutyraldehyde, n-valeraldehyde, isovaleraldehyde, n-capronaldehyde, isocapronaldehyde or 2-methylvaleraldehyde.

The phenols are advantageously substituted phenols having a total of one or two C₁-C₄ alkyl and/or C₁-C₄ alkoxy groups. Preferred phenols are 3-methylphenol, 2-ethylphenol, 4-ethyl phenol, 2-isopropylphenol, 2-tert-butylphenol, 2-tert-butyl-4-methylphenol, 2-methoxyphenol, 2-methoxy-4-methylphenol and 2-methyl-5-isopropylphenol. C₁-C₄ monoalkylated phenols are particularly preferred.

Advantageous anisoles are anisole, 2-methylanisole, 4-allylanisole or 4-methylanisole.

The pyrazines are advantageously alkylated and/or acylated pyrazines. Advantageous pyrazines are, for example, 2-methylpyrazine, 2-ethylpyrazine, 2,3-dimethylpyrazine, 2,3-diethylpyrazine, 2,6-dimethylpyrazine, 2,3-methylethylpyrazine, 5,2-methylethylpyrazine, 2,3,5-trimethylpyrazine, 3,5,2-dimethylethylpyrazine, 3,6,2-dimethylethylpyrazine, 5,2,3-methyldiethylpyrazine, tetramethylpyrazine, 2,3-methylacetylpyrazine or 2-acetylpyrazine. Pyrazines having a total of one to three, particularly preferably a total of one or two, C₁-C₄ alkyl and/or C₁-C₄ acyl groups are preferred.

The acylated pyrazines are preferably monoacylated and particularly preferably have an acetyl or propionyl group, monoacylated pyrazines, in particular 2-acetyl pyrazine, being preferred.

The compounds from group C) are typically contained in the mixtures for use according to the invention in a proportion of 0.5-20 wt. %, advantageously 1-10 wt. %, preferably 1-5 wt. %.

A ratio by weight of components B) to components C) in the range from 6:1 to 1:3, preferably in the range from 5:1 to 1:2 and particularly preferably 4:1 to 1:1 is advantageous.

Common antioxidants can be added to the odorant for use according to the invention as component D), to increase stability for example. Examples which can be cited include vitamin C and derivatives (e.g. ascorbyl palmitate, ascorbyl acetate), tocopherols and derivatives (e.g. vitamin E, vitamin E acetate), vitamin A and derivatives (vitamin A palmitate), phenolic benzylamines, formic acid, acetic acid, benzoic acid, sorbic acid, hexamethylene tetramine, tert-butyl hydroxytoluene, tert-butyl hydroxyanisole, α-hydroxy acids (e.g. citric acid, lactic acid, malic acid), hydroquinone monomethyl ether. Preferred antioxidants are tert-butyl hydroxytoluene (BHT, ionol), tert-butyl hydroxyanisole and hydroquinone monomethyl ether.

Through the addition of antioxidants, a high storage stability in particular is achieved in the mixtures for use according to the invention and in the odorised natural gas. Storage stability tests have shown that the warning odour of the mixtures for use according to the invention remains largely unchanged over a period of more than 5 months at 40° C. (incubator). For the odorants according to the invention, tert-butyl hydroxytoluene and hydroquinone monomethyl ether have proved to be particularly effective and to have a good stabilising effect.

More than one antioxidant can also be added to an odorant. The odorants advantageously contain one, two or three antioxidants, one or two antioxidants being preferred.

The total amount of antioxidants (component D) in the odorant is conventionally in the range from 0.01 to 2 wt. %, preferably in the range from 0.02 to 1 wt. %, particularly preferably in the range from 0.03 to 0.6 wt. %.

The amount of odorant based on the fuel gas to be odorised is typically in the range from 5 to 100 mg/m³, preferably 5 to 50 mg/m³, particularly preferably 10 to 40 mg/m³ and most particularly preferably 12 to 30 mg/m³.

The warning odour of a natural gas odorised according to the invention was perceived by a group of testers to be unambiguous, even in a dilution of natural gas in air in the range from 1:200 to 1:2000.

Through the presence of component C) in the mixtures for use according to the invention, a better warning odour was achieved in comparison to mixtures containing only components A) and B), see also the examples below in this respect.

Preference is given according to the invention to the use of mixtures containing
A) at least two different acrylic acid C₁-C₄ alkyl esters;
B) at least one compound from the group comprising C₁-C₈ mercaptans, C₄-C₈ thiophenes, C₂-C₈ sulfides or C₂-C₈ disulfides;
C) at least one compound from the group comprising norbornenes, C₂-C₈ carboxylic acids, C₂-C₅ aldehydes, C₆-C₁₀ phenols, C₇-C₁₀ anisoles or C₄-C₁₀ pyrazines and
D) at least one antioxidant.

Particular preference is given according to the invention to the use of mixtures containing
A) acrylic acid methyl ester and acrylic acid ethyl ester;
B) at least one compound from the group comprising thiophene, tetrahydrothiophene, dimethyl sulfide, diethyl sulfide, di-n-propyl sulfide, diisopropyl sulfide, dimethyl disulfide, diethyl disulfide, di-n-propyl disulfide, diisopropyl disulfide or the mercaptans having the formula (I)

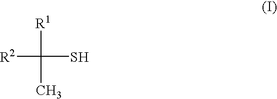

5 wherein
R¹ denotes hydrogen, methyl or ethyl, preferably methyl, and
R² denotes an alkyl group having 1 to 4 carbon atoms, preferably methyl, ethyl, isopropyl, isobutyl or tert-butyl;
C) at least one compound from the group comprising C₂-C₅ carboxylic acids, C₃-C₅ aldehydes, C₁-C₄ monoalkylated phenols;
D) at least one antioxidant.

Preferred components B) here are the mercaptans having the formula (I).

Most particular preference is given to the use of mixtures containing or consisting of
A) acrylic acid methyl ester and acrylic acid ethyl ester;
B) tert-butyl mercaptan;
C) at least one compound from the group comprising propionaldehyde, isovaleraldehyde, isovaleric acid, 2-ethylphenol, 4-ethylphenol;
D) one or two antioxidants.

The best odorisation of the gas was achieved with these mixtures, the warning odour was most strongly pronounced and was perceived as being unambiguous.

The most preferred compound from group C) is isovaleric acid, the most preferred antioxidants from group D) are hydroquinone monomethyl ether and tert-butyl hydroxytoluene.

The processes according to the invention correspond to the uses according to the invention, in particular with regard to the preferred embodiments. Further aspects of the invention follow from the appended claims.

The examples below illustrate the invention:

Unless otherwise specified, all figures stated relate to the weight.

### Key:

MeAc: methyl acrylate; EtAc: ethyl acrylate; TBM: tert-butyl mercaptan; IVA isovaleric acid; BHT: tert-butyl hydroxytoluene.

### EXAMPLE 1

Components A), B) and C) of odorants for use according to the invention were evaluated as individual substances in concentrations of 10, 25 and 50 mg/m³ of natural gas (natural gas L; methane content: approx. 85 vol. %) in olfactory terms with regard to their warning odour and their warning intensity in comparison to non-odorised natural gas (blank value). These concentrations correspond to the typical concentrations of odorant in natural gas in conventional conditions or in the case of increased odorisation. Odorised natural gas containing the same concentrations of THT was used as a reference.

The experiment was performed at room temperature (approximately 20° C.) by metering the odorant into a gas stream in a pipe. At the end of this 2 m pipe (homogenisation takes place inside the pipe) the odour of the emerging odorised gas is evaluated by a group of trained testers (8 to 12 people). The evaluation was made on a scale from 1 (very weak/negligible warning effect) to 10 (very strong/strong warning effect); the stated values are mean values. The industry standard THT was given the value 10.

The results were substantially the same for the three concentrations that were tested (10, 25 and 50 mg/m³ gas). Table 1 compares THT and components A), B) or C) for use according to the invention as individual substances (i.e. not in the form of the mixture for use according to the invention).

TABLE 1

| Substance | Substance | MeAc | EtAc | Rating |
|---|---|---|---|---|
| Tetrahydrothiophene | 100 | — | — | 10 |
| Acrylic acid ethyl ester | | — | 100 | 5 |
| Acrylic acid methyl ester | | 100 | — | 4.5 |
| Acrylic acid n-butyl | 100 | — | — | 3.5 |
| ester | | | | |
| tert-Butyl mercaptan | 100 | — | — | 7 |
| Propionaldehyde | 100 | — | — | 3 |
| Isovaleric acid | 100 | — | — | 3.5 |
| Isovaleraldehyde | 100 | — | — | 3.5 |
| 2-Ethylphenol | 100 | — | — | 3 |
| 4-Ethylphenol | 100 | — | — | 3 |

It can be seen from Table 1 that the individual components A), B) or C) do not have a good odorising effect.

### EXAMPLE 2

Table 2 shows the ratings for mixtures comprising two compounds of component type A) with TBM=tert-butyl mercaptan (methyl propane thiol-2,2) as component B); the procedure was the same as that described in Example 1.

TABLE 2

| EtAc | MeAc | TBM | Rating |
|---|---|---|---|
| 60.0 | 40.0 | — | 6 |
| 60.0 | 39.0 | 1.0 | 7 |
| 60.0 | 37.5 | 2.5 | 7 |
| 60.0 | 35.0 | 5.0 | 7 |
| 60.0 | 32.5 | 7.5 | 8 |
| 60.0 | 30.0 | 10.0 | 8 |
| 55.0 | 30.0 | 15.0 | 7 |
| 55.0 | 25.0 | 20.0 | 7 |
| 50.0 | 25.0 | 25.0 | 7 |

It can be seen from Table 2 that the addition of TBM brought about an improved odorising performance, although very good odorisation was still not possible.

### EXAMPLE 3

Table 3 shows the ratings for mixtures comprising two compounds of component type A) with IVA=isovaleric acid as component C), the procedure was the same as that described in Example 1.

TABLE 3

| EtAc | MeAc | IVA | Rating |
|---|---|---|---|
| 60.0 | 39.0 | 1.0 | 7 |
| 60.0 | 37.5 | 2.5 | 8 |
| 60.0 | 35.0 | 5.0 | 8 |
| 60.0 | 32.5 | 7.5 | 7 |
| 60.0 | 30.0 | 10.0 | 7 |
| 55.0 | 30.0 | 15.0 | 7 |
| 55.0 | 25.0 | 20.0 | 6 |
| 50.0 | 25.0 | 25.0 | 6 |

It can be seen from Table 3 that the addition of IVA brought about an improved odorising performance, although very good odorisation was still not possible.

### EXAMPLE 4

Table 4 shows the ratings for mixtures comprising two compounds of component type A) with TBM=tert-butyl mercaptan as component B) and IVA=isovaleric acid as component C); the procedure was the same as that described in Example 1.

TABLE 4

| EtAc | MeAc | TBM | IVA | Rating |
|---|---|---|---|---|
| 60.0 | 36.5 | 2.5 | 1.0 | 8 |
| 60.0 | 32.5 | 2.5 | 5.0 | 8.5 |
| 60.0 | 34.0 | 5.0 | 1.0 | 8.5 |
| 60.0 | 31.0 | 5.0 | 4.0 | 9 |
| 60.0 | 30.0 | 5.0 | 5.0 | 9 |
| 60.0 | 29.0 | 5.0 | 6.0 | 8.5 |
| 60.0 | 33.0 | 6.0 | 1.0 | 9 |
| 60.0 | 31.0 | 6.0 | 3.0 | 10 |
| 60.0 | 29.0 | 6.0 | 5.0 | 9 |
| 55.0 | 31.0 | 6.0 | 8.0 | 8.5 |
| 60.0 | 32.0 | 7.0 | 1.0 | 9 |
| 60.0 | 31.0 | 7.0 | 2.0 | 10 |
| 60.0 | 30.0 | 7.0 | 3.0 | 10 |
| 60.0 | 29.0 | 7.0 | 4.0 | 10 |
| 60.0 | 28.0 | 7.0 | 5.0 | 9 |
| 60.0 | 31.0 | 8.0 | 1.0 | 8.5 |
| 60.0 | 29.0 | 8.0 | 3.0 | 9 |
| 60.0 | 28.0 | 8.0 | 4.0 | 9.5 |
| 55.0 | 30.0 | 8.0 | 7.0 | 8.5 |
| 60.0 | 30.0 | 9.0 | 1.0 | 8.5 |
| 60.0 | 28.0 | 9.0 | 3.0 | 9 |
| 60.0 | 27.0 | 9.0 | 4.0 | 9 |
| 60.0 | 26.0 | 9.0 | 5.0 | 9 |
| 55.0 | 29.0 | 9.0 | 7.0 | 8.5 |
| 60.0 | 29.0 | 10.0 | 1.0 | 8 |
| 60.0 | 26.0 | 10.0 | 4.0 | 8.5 |
| 60.0 | 25.0 | 10.0 | 5.0 | 9 |
| 55.0 | 29.0 | 10.0 | 6.0 | 9 |
| 60.0 | 26.0 | 12.0 | 2.0 | 8.5 |
| 55.0 | 29.0 | 12.0 | 4.0 | 9 |
| 55.0 | 28.0 | 12.0 | 5.0 | 9 |
| 55.0 | 27.0 | 12.0 | 6.0 | 8.5 |

Table 4 shows that the use of mixtures comprising components A), B) and C) brings about an outstanding odorising performance.

### EXAMPLE 5

To investigate the storage stability, odorants with various antioxidants were added to natural gas L and the odorised natural gas was tested in olfactory terms as described in Example 1 after specified periods of storage at 40° C. The criterion for storage stability was the significant olfactory agreement of the stored odorant or of the stored odorised gas with the original warning odour.

The amount of odorant added to the natural gas was 20 mg/m³. The odorant consisted of 60% ETAC less y % antioxidant, 31% MeAc, 7% TBM, 2% IVA and y % antioxidant. Table 5 shows a comparison of the results.

Classification of storage stability: a=less than 6 weeks; b=max. 3 months; c=max. 5 months; d=more than 5 months

TABLE 5

| | | Storage |
|---|---|---|
| Antioxidant | y % | stability |
| No antioxidant | — | a |
| BHT | 0.05 | b |
| BHT | 0.10 | d |
| BHT | 0.30 | d |
| BHT | 0.50 | d |
| BHT | 1.00 | b |
| Hydroquinone monomethyl ether | 0.05 | d |
| Hydroquinone monomethyl ether | 0.10 | d |
| Hydroquinone monomethyl ether | 0.30 | c |
| Hydroquinone monomethyl ether | 0.50 | c |
| Hydroquinone monomethyl ether | 1.00 | c |

With a suitable choice and dosage of antioxidant, the warning odour of both the stored odorant itself and of the odorised natural gas was still highly noticeable even after a storage period of more than 5 months at 40° C.

1. A method for providing a detectable odor to a fuel gas having a methane content of at least 60 wt. % by adding to said fuelgas a mixture containing
A) at least two different acrylic acid C₁-C₆ alkyl esters;
B) at least one compound from the group comprising C₁-C₈ mercaptans, C₄-C₁₂ thiophenes, C₂-C₈ sulfides or C₂-C₈ disulfides; and
C) at least one compound from the group comprising norbornenes, C₁-C₆ carboxylic acids, C₁-C₈ aldehydes, C₆-C₁₄ phenols, C₇-C₁₄ anisoles or C₄-C₁₄ pyrazines.

2. Use A method according to claim 1, wherein the mixture contains
A) at least two different acrylic acid C₁-C₄ alkyl esters;
B) at least one compound from the group comprising C₁-C₈ mercaptans, C₄-C₈ thiophenes, C₂-C₈ sulfides or C₂-C₈ disulfides;
C) at least one compound from the group comprising norbornenes, C₂-C₅ carboxylic acids, C₂-C₅ aldehydes, C₆-C₁₀ phenols, C₇-C₁₀ anisoles or C₄-C₁₀ pyrazines and
D) at least one antioxidant.

3. A method according to claim 1, wherein the mixture contains
A) acrylic acid methyl ester and acrylic acid ethyl ester;
B) at least one compound from the group comprising thiophene, tetrahydrothiophene, dimethyl sulfide, diethyl sulfide, di-n-propyl sulfide, diisopropyl sulfide, dimethyl disulfide, diethyl disulfide, di-n-propyl disulfide, diisopropyl disulfide or the mercaptans having the formula (I) 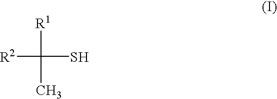
wherein
R¹ denotes hydrogen, methyl or ethyl, and
R² denotes an alkyl group having 1 to 4 carbon atoms;
C) at least one compound from the group comprising C₂-C₅ carboxylic acids, C₃-C₅ aldehydes, C₁-C₄ monoalkylated phenols; and
D) at least one antioxidant.

4. Use A method according to claim 1, wherein the mixture comprises
A) acrylic acid methyl ester and acrylic acid ethyl ester;
B) tert-butyl mercaptan;
C) at least one compound from the group comprising propionaldehyde, isovaleraldehyde, isovaleric acid, 2-ethylphenol, 4-ethylphenol; and
D) one or two antioxidants.

5. A method according to claim 1, characterised in that the mixture contains tert-butyl hydroxytoluene or hydroquinone monomethyl ether as an antioxidant.

6. A method according to claim 1, characterised in that the mixture contains:
60 to 97 wt. % of component A),
1 to 30 wt. % of component B),
0.5 to 20 wt. % of component C), and
0.01 to 2 wt. % of component D).

7. A method according to claim 1, characterised in that the mixture contains:
70 to 95 wt. % of components A),
2 to 25 wt. % of components B),
1 to 10 wt. % of components C), and
0.02 to 1 wt. % of components D).

8. A method according to claim 1, characterised in that the ratio by weight of component B) to component C) is in the range from 6:1 to 1:3.

9. Fuel gas with a methane content of at least 60 wt. %, and containing an odorization mixture comprising:
A) at least two different acrylic acid C₁-C₆ alkyl esters:
B) at least one compound from the group comprising C₁-C₈ mercaptans, C₄-C₁₂ thiophenes, C₂-C₈ sulfides or C₂-C₈ disulfides; and
C) at least one compound from the group comprising norbornenes, C₁-C₆ carboxylic acids, C₁-C₈ aldehydes, C₆-C₁₄ phenols, C₇-C₁₄ anisoles or C₄-C₁₄ pyrazines.

10. Fuel gas according to claim 9, characterised in that the fuel gas is natural gas.

11. (canceled)

12. Process according to claim 1, characterised in that the mixture is added to the fuel gas in a quantity of 5 to 100 mg per m³ of gas.
